(19) United States
(12) Patent Application Publication
(10) Pub. No.: US 2025/0243351 A1
(43) Pub. Date: Jul. 31, 2025

(54) POLYETHYLENE RECYCLATE BLEND PRODUCTS

(71) Applicant: Equistar Chemicals, LP, Houston, TX (US)

(72) Inventors: Sameer D. Mehta, Mason, OH (US); Benjamin P. Mills, Mequon, WI (US); Michael Camara, Cincinnati, OH (US); Harilaos Mavridis, Lebanon, OH (US)

(73) Assignee: Equistar Chemicals, LP, Houston, TX (US)

(21) Appl. No.: 19/039,280

(22) Filed: Jan. 28, 2025

Related U.S. Application Data
(60) Provisional application No. 63/626,453, filed on Jan. 29, 2024.
(60) Provisional application No. 63/631,829, filed on Apr. 9, 2024.

(51) Int. Cl. C08L 23/06; C08K 5/14

(52) U.S. Cl. CPC C08L 23/06; C08K 5/14; C08L 2205/025; C08L 2205/06; C08L 2207/062; C08L 2207/20

(57) ABSTRACT

Compositions comprising a blend of a filled HDPE recyclate component and a virgin PE component are provided. The HDPE recyclate component can have one or more HDPE recyclates, including homopolymers, copolymers, interpolymers or combination thereof, in addition to one or more virgin PEs The blends demonstrate improved ESCR performance relative to currently available HDPE products at a given density. The blends can be extruded to form, for example, conduits.

### PRIOR RELATED APPLICATIONS

This application claims the benefit of priority to U.S. Provisional Application No. 63/626,453, filed on Jan. 29, 2024, and 63/631,829, filed on Apr. 9, 2024, which are incorporated here by reference in their entirety.

### FIELD OF THE INVENTION

The present disclosure relates to blends of a high density polyethylene recyclate with a virgin polyethylene.

### BACKGROUND OF THE INVENTION

Polyolefins, in particular polyethylene, are increasingly consumed in large amounts for many applications, including packaging for food and other goods, electronics, automotive components, and a great variety of manufactured articles. Large amounts of waste plastic materials are presently coming from differential recovery of municipal plastic wastes, mainly constituted of flexible packaging (cast film, blown film and BOPP film), rigid packaging, blow molded bottles and injection molded containers. Usually, through a step of separation from other polymers, such as PVC, PET or PS, polyethylene (PE) fractions, in particular, high density polyethylene (HDPE) recyclate can be recovered.

Applications for use of HDPE resins commonly include, but are not limited to, small blow-molding, caps and closures, jerry cans, high molecular weight films, injection molding, conduit, industrial bulk containers, and the like. Direct reuse of such HDPE recyclate is typically limited in that these materials suffer from a loss of cracking resistance, melt strength, and/or impact strength relative to virgin HDPEs having similar density and high load melt index. Many HDPE recyclate also contain fillers and other additives that may further negatively impact properties. Thermally and/or catalytically degrading polymer recyclate allows for recovery of the monomeric building blocks of polymers as feedstock for manufacture of new polymers with the desired properties. However, this requires additional processing steps that are energy intensive and, in some instances, result in the generation of undesirable byproducts requiring yet more processing steps for desirable disposition of such byproducts.

It would be desirable to more directly place HDPE recyclate back into the stream of commerce while minimizing the additional processing steps required to do so. There is a need to provide processes to produce PE compositions comprising recycled HDPE, such HDPE compositions having a useful combination of properties that are equal to or better than analogous virgin HDPE compositions. Ideally, such processes would be highly flexible and could be implemented with commonly used equipment and familiar techniques to produce a wide variety of products.

### SUMMARY OF THE INVENTION

In general, the present disclosure relates to compositions comprising a blend of a filled recyclate HDPE component and a virgin PE component. The filled recyclate HDPE component can have one or more fillers and, optionally, one or more additives. The fillers can pose problems when utilizing recyclate such as a detrimental impact on ESCR and tensile elongation at break of the final material. Further, fillers raise the density of a recyclate, making it hard to select a suitable material for a particular application. Rather, additional analysis steps to determine other chemical or physical properties are required to select a suitable recyclate because the final properties of the blend are not necessarily foreseeable.

In some embodiments, the filled HDPE recyclate component is present in the blend in an amount in the range of from 20 wt. % to 95 wt. %, and the virgin PE component is present in the blend in an amount in the range of from 5 wt. % to 80 wt. %, wherein weight percentages are based on the total weight of filled HDPE recyclate component and the virgin PE component.

In some embodiments, the filled HDPE recyclate component has a density in the range of from 0.950 g/cm³ to 0.970 g/cm³, an ash content of 5,000 ppm to 20,000 ppm, a melt index (15) in the range of from 1.50 g/10 min. to 7.0 g/10 min., and an environmental stress crack resistance (“ESCR”) F10 in the range of from about 10 hours to about 24 hours in 10% Igepal.

In some embodiments, the virgin PE component has a density in the range of from 0.938 g/cm³ to 0.954 g/cm³, a melt index (I₅) in the range of from 0.10 g/10 min. to 2.0 g/10 min., and an environmental stress crack resistance (“ESCR”) F50 greater than or equal to 1,000 hours in 10% Igepal.

In some embodiments, the blend have a flexural modulus in the range of 110,000 to 170,000 PSI, a melt index (I₅) in the range of from 0.20 g/10 min. to 4.0 g/10 min., a tensile strength at yield of about 3,000 to about 4,000 PSI, a high load melt index (HLMI) in the range of from 10 g/10 min. to 60 g/10/min, and an environmental stress crack resistance (“ESCR”) F50 in the range of from 24 hours to greater than 1,000 hours in 100% Igepal and/or from 24 hours to greater than 1,000 hours in 10% Igepal and/or an ESCR F10 in the range of greater than or equal to 96 hours in 10% Igepal.

In some embodiments, the blend composition is produced by melt blending the filled HDPE recyclate and virgin PE components, and optionally primary and/or secondary antioxidants, to form a pelletized product.

In some embodiments, the blend composition is suitable for conduit applications and has a flexural modulus in the range of 100,000 to 170,000 PSI, a tensile strength at yield in the range of about 3,000 to about 4,000 PSI, and an ESCR F10 at 10% Igepal of greater than or equal to 96 hours.

In some embodiments, the blend composition, including any option additives or fillers, is extruded as a conduit.

The foregoing has outlined rather broadly the features and technical advantages of the present invention in order that the detailed description of the invention that follows may be better understood. Additional features and advantages of the invention will be described hereinafter, which form the subject matter of the claims of the invention. It should be appreciated by those skilled in the art that the conception and specific embodiments disclosed may be readily utilized as a basis for modifying or designing other film structures and/or processes for carrying out the same purposes of the present invention. It should also be realized by those skilled in the art that such equivalent constructions do not depart from the spirit and scope of the invention as set forth in the appended claims. The novel features which are believed to be characteristic of the invention, both as to its structure and method of manufacture, together with further objects and advantages will be better understood from the following description.

### DETAILED DESCRIPTION OF THE INVENTION

Illustrative embodiments of the subject matter claimed below will now be disclosed. In the interest of clarity, some features of some actual implementations may not be described in this specification. It will be appreciated that in the development of any such actual embodiments, numerous implementation-specific decisions must be made to achieve the developer's specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than the broadest meaning understood by skilled artisans, such a special or clarifying definition will be expressly set forth in the specification in a definitional manner that provides the special or clarifying definition for the term or phrase. It must also be noted that, as used in the specification and the appended claims, the singular forms “a,” “an,” and “the” include plural references unless otherwise specified.

For example, the following discussion contains a non-exhaustive list of definitions of several specific terms used in this disclosure (other terms may be defined or clarified in a definitional manner elsewhere herein). These definitions are intended to clarify the meanings of the terms used herein. It is believed that the terms are used in a manner consistent with their ordinary meaning, but the definitions are nonetheless specified here for clarity.

### Definitions

“Antioxidant agents,” as used herein, means compounds that inhibit oxidation, a chemical reaction that can produce free radicals and chain reactions. Antioxidants are differentiated based on their reaction mechanisms and include: (1) primary antioxidants, and (2) secondary antioxidants.

“Compounding conditions,” as used herein, means temperature, pressure, and shear force conditions implemented in an extruder to provide intimate mixing of two or more polymers and optionally additives to produce a substantially homogeneous polymer product.

“HDPE recyclate,” as used herein, means a portion of polyolefin recyclate having a density in the range of 0.950 g/cm³ to 0.970 g/cm³. Filled HDPE recyclate has a larger density than unfilled HDPE recyclate due to the presence of the fillers and/or other additives. The change in density (A density) is estimated to be 6.7E-7 multiplied by the ppm of the filler/additive. For example, an filled HDPE recyclate having a density of 0.965 g/cm³ and an ash content of 4000 ppm would have an unfilled HDPE recyclate density of 0.96232 g/cm³.

“PE,” as used herein, means ethylene homopolymers and ethylene copolymers produced in a gas phase and/or slurry phase polymerization. The PE can comprise homopolymers and/or copolymers of units derived from ethylene and units derived from one or more of C₃-C₁₂ α-olefins. Such C₃-C₁₂ α-olefins include, but are not limited to, substituted or unsubstituted C₃ to C₁₂ alpha olefins such as propylene, butene, pentene, hexene, heptene, octene, nonene, decene, undecene, dodecane, and isomers thereof. When present, comonomers can be present in amounts up to 20 wt. %, 15 wt. %, 10 wt. %, or 5 wt. %.

“Polyolefin recyclate,” as used herein, means post-consumer recycled (“PCR”) polyolefin and/or post-industrial recycled (“PIR”) polyolefin. Polyolefin recyclate is derived from an end product that has completed its life cycle as a consumer item and would otherwise be disposed of as waste (e.g., a polyethylene water bottle) or from plastic scrap that is generated as waste from an industrial process. Post-consumer polyolefins include polyolefins that have been collected in commercial and residential recycling programs, including flexible packaging (cast film, blown film and BOPP film), rigid packaging, blow molded bottles, and injection molded containers. Usually, through a step of separation from other polymers, such as nylon, polyamides, PVC, PET or PS, two main polyolefinic fractions are obtained, namely polyethylene recyclate (including HDPE, MDPE, LDPE, and LLDPE) and polypropylene recyclate (including homopolymers, random copolymers, and heterophasic copolymers). Polyethylene recyclate can be further separated to recover a portion having polyolefin as the primary constituent. In addition to contamination from dissimilar polymers, polyolefin recyclate frequently contains other impurities such as PMMA, PC, wood, paper, textile, cellulose, food, and other organic wastes, many of which cause the polyolefin recyclate to have an unpleasant odor before and after typical processing.

“Primary antioxidants,” as used herein, means compounds which function essentially as free radical terminators or scavengers. Primary antioxidants react rapidly with peroxy and alkoxy radicals. The majority of primary antioxidants for polymers are sterically hindered phenols.

“Processability,” as used herein, refers to how well a polymer composition can be formed into a cast of blown film of commercial quality or molded by injection or compression molding into a molded article of commercial quality at commercially acceptable rates using the equipment and conditions.

“Secondary antioxidants,” as used herein, means compounds which are preventive antioxidants that function by retarding chain initiation. Secondary antioxidants react with hydroperoxides to yield non-radical products and are, therefore, frequently called hydroperoxide decomposers.

“Virgin PE,” as used herein, are pre-consumer polyethylenes. Pre-consumer PEs are products obtained directly or indirectly from petrochemical feedstocks fed to a polymerization apparatus. Pre-consumer polyolefins can be subjected to post polymerization processes such as, but not limited to, extrusion, pelletization, peroxidation, visbreaking, and/or other processing completed before the product reaches the end-use consumer. In some embodiments, virgin polyolefins have a single heat history. In some embodiments, virgin polyolefins have more than one heat history.

### PE Blend Compositions

Disclosed herein are compositions comprising a blend of a filled HDPE recyclate component and a virgin PE blend component. The blends have a flexural modulus in the range of 110,000 to 170,000 PSI, a melt index (I₅) in the range of from 0.20 g/10 min. to 4.0 g/10 min., a tensile strength at yield of about 3,000 to about 4,000 PSI, a high load melt index (HLMI) in the range of from 10 g/10 min. to 60 g/10/min, and an environmental stress crack resistance (“ESCR”) F10 greater than or equal to 96 hours in 10% Igepal.

In some embodiments, the filled HDPE recyclate component is present in the blend amount in the range of from 20 wt. % to 95 wt. %, from 50 wt. % to 90 wt. %, from 60 wt. % to 85 wt. %, or from 70 wt. % to 80 wt. %. Correspondingly, the virgin PE component is present in the blend amount in the range of from 5 wt. % to 80 wt. %, from 10 wt. % to 50 wt. %, from 15 wt. % to 40 wt. %, or from 20 wt. % to 30 wt. %. All weight percentages are based on the total weight of the filled HDPE recyclate component and the virgin PE component.

In some embodiments, the blend composition has one of more of:
a) a number average molecular weight (Mₙ) in the range of from 8,000 g/mol to 20,000 g/mol;
b) a weight average molecular weight (M_{w}) in the range of from 130,000 g/mol to 275,000 g/mol or from 156,000 g/mol to 194,000 g/mol;
c) a molecular weight distribution (MWD) in the range of from 7 to 20 or from 10 to 15; and,
d) a density in the range of from 0.940 g/cm³ to 0.962 g/cm³ or from 0.956 g/cm³ to 0.960 g/cm³.

In some embodiments, the blend composition has one of more of:
a) an overall polydispersity ratio (PDR) in the range of from 15 to 80 or;
b) a zero shear viscosity (η₀) in the range of from 1.0×10⁶ to 1.0×10⁸; and
c) a long chain branching index (LCBI) in the range of from 0.1 to 3.

In some embodiments, the filled HDPE recyclate component and the second HDPE component are melt blended at a temperature in the range of from 150° C. to 250° C. to form the composition.

In some embodiments, the blend further comprises a primary antioxidant, a secondary antioxidant, or a combination thereof. In further embodiments, the primary antioxidant is present in the blend in an amount less than or equal to 1,500 ppm and the secondary antioxidant is present in the blend in an amount less than or equal to 1,500 ppm, wherein ppm values are based on the total weight of the filled HDPE recyclate component and the virgin PE component.

### Filled HDPE Recyclate Compositions

The filled HDPE recyclate component has an ash content in the range of 5,000 ppm to 20,000 ppm, or from 12,000 to 16,000 ppm; a melt index (I₅) in the range of from 1.50 g/10 min. to 7.00 g/10 min.; and an ESCR F10 from about 10 hours to about 24 hours in 10% Igepal.

In some embodiments, the filled HDPE recyclate component has one or more of:
a) a number average molecular weight (Mₙ) in the range of from 8,000 g/mol to 20,000 g/mol or from 12,000 g/mol to 16,000 g/mol;
b) a weight average molecular weight (M_{w}) in the range of from 100,000 g/mol to 170,000 g/mol or from 115,000 g/mol to 145,000 g/mol;
c) a molecular weight distribution (MWD) in the range of from 5 to 14 or from 6 to 9;
d) a high load melt index (HLMI) in the range of from 35 g/10 min. to 90 g/10/min. or from 40 g/10 min. to 65 g/10/min.;
e) an average molecular weight (M_{z}) in the range of from 300,000 g/mol to 2,000,000 g/mol;
f) a z+1 average molecular weight (M_{z}+1) in the range of from 1,000,000 g/mol to 3,500,000 g/mol;
g) a density in the range of from 0.950 g/cm³ to 0.970 g/cm³; and,
h) a 2% flexural modulus in the range of from 145,000 PSI to 230,000 PSI or from 180,000 PSI to 210,000 PSI.

In some embodiments, the filled HDPE recyclate component has one or more of a zero shear viscosity (η₀) in the range of from 5.0×10⁶ to 1.0×10⁸, a viscosity ratio in the range of from 0.800 to 1.5, and a long chain branching index (LCBI) in the range of from 0.1 to 4.0.

In some embodiments, the filled HDPE recyclate component comprises one or more filled HDPE recyclate or a combination of filled HDPE recyclate with one or more unfilled HDPE recyclates.

In some embodiments, the filled HDPE recyclate component comprises one or more filled HDPE copolymer recyclates, alone or in combination with one or more unfilled HDPE homopolymer or copolymer recyclates.

In some embodiments, the filled HDPE recyclate component comprises one or more filled HDPE copolymer recyclates and one or more filled HDPE homopolymer, alone or in combination with one or more unfilled HDPE homopolymer or copolymer recyclates.

### Virgin PE Blend Compositions

The virgin PE component has a density in the range of from 0.938 g/cm³ to 0.954 g/cm³, a melt index (I₅) in the range of from 0.10 g/10 min. to 2.00 g/10 min., and an ESCR F50 of greater than or equal to 1,000 hours in 10% Igepal and 100% Igepal.

In some embodiments, the virgin PE component has one or more of:
a) a number average molecular weight (Mₙ) in the range of from 7,000 g/mol to 25,000 g/mol or from 12,000 g/mol to 22,000 g/mol;
b) a weight average molecular weight (M_{w}) in the range of from 100,000 g/mol to 1,000,000 g/mol or from 200,000 g/mol to 300,000 g/mol
c) a molecular weight distribution (MWD) in the range of from 5 to 40 or from 7 to 30;
d) a high load melt index (HLMI) in the range of from 5 g/10 min. to 40 g/10/min. or from 7 g/10 min. to 30 g/10/min.;
e) an average molecular weight (M_{z}) in the range of from 500,000 g/mol to 2,000,000 g/mol;
f) a z+1 average molecular weight (M_{z}+1) in the range of from 1,000,000 g/mol to 3,500,000 g/mol; and,
g) a 2% flexural modulus in the range of from 80,000 PSI to 180,000 PSI or from 136,000 PSI to 146,000 PSI.

In some embodiments, the virgin PE component has one or more of a zero shear viscosity (η₀) in the range of from 1.0×10⁵ to 1.0×10⁸, a bulk intrinsic viscosity ([η]) in the range of from 1.50 to 3.00, a viscosity ratio in the range of from 0.800 to 1.150, and a long chain branching index (LCBI) in the range of from 0.05 to 3.0.

In some embodiments, the virgin PE component comprises one or more PE homopolymers, one or more PE copolymers, or a combination thereof.

In some embodiments, the virgin PE component comprises one or more middle density PE, one or more high density PE, or a combination thereof.

### Polyethylene

In some embodiments, the PE described herein comprise homopolymers and/or copolymers of units derived from ethylene and units derived from one or more of C₃-C₁₂ α-olefins.

Such ethylene homopolymers and/or copolymers can be produced in a suspension, solution, slurry, or gas phase process, using known equipment and reaction conditions. In some embodiments, polymerization temperatures range from about 0° C. to about 300° C. at pressures of from about 1 PSIg (6.9 kPag) to 1,000 PSIg (6.9 MPag).

Slurry or solution polymerization systems can utilize subatmospheric (below 1 atm or ˜14.7 PSIg, or from 1 to less than 14.7 PSIg), atmospheric pressures (about 1 atm or ˜14.7 PSIg) or superatmospheric pressures (above 1 atm or ˜14.7 PSIg, or greater than 1 to about 1,000 PSIg) and temperatures in the range of about 40° C. to about 300° C. An exemplary liquid phase polymerization system is described in U.S. Pat. No. 3,324,095, the disclosure of which is fully incorporated by reference herein. Liquid phase polymerization systems generally comprise a reactor to which olefin monomer and catalyst composition are added, and which contains a liquid reaction medium for dissolving or suspending the polyolefin. The liquid reaction medium may consist of the bulk liquid monomer or an inert liquid hydrocarbon that is nonreactive under the polymerization conditions employed. Although such an inert liquid hydrocarbon need not function as a solvent for the catalyst composition or the polymer obtained by the process, it usually serves as solvent for the monomers employed in the polymerization. Among the inert liquid hydrocarbons suitable for this purpose are isopentane, hexane, cyclohexane, heptane, benzene, toluene, and the like. Reactive contact between the olefin monomer and the catalyst composition should be maintained by constant stirring or agitation. The reaction medium containing the olefin polymer product and unreacted olefin monomer is withdrawn from the reactor continuously. The olefin polymer product is separated, and the unreacted olefin monomer and liquid reaction medium are recycled into the reactor.

Gas phase polymerization systems can utilize pressures in the range of from 1 psig (6.9 kPag) to 1,000 psig (6.9 MPag), 50 psig (344 kPag) to 400 psig (2.8 MPag), or 100 psig (689 kPag) to 300 psig (2.1 MPag), and temperatures in the range of from 30° C. to 130° C. or 65° C. to 110° C. Gas phase polymerization systems can be stirred or fluidized bed systems. In some embodiments, a gas phase, fluidized bed process is conducted by passing a stream containing one or more olefin monomers continuously through a fluidized bed reactor under reaction conditions and in the presence of catalyst composition at a velocity sufficient to maintain a bed of solid particles in a suspended condition. A stream containing unreacted monomer is withdrawn from the reactor continuously, compressed, cooled, optionally partially or fully condensed, and recycled into the reactor. Product is withdrawn from the reactor and make-up monomer is added to the recycle stream. As desired for temperature control of the polymerization system, any gas inert to the catalyst composition and reactants may also be present in the gas stream.

In some embodiments, a catalyst based on a Group VIB metal is used. In some embodiments the catalyst is a chromium-based catalyst. Such PE homopolymers and/or copolymers have some long-chain branching and a density in the range of from 0.940 g/cm³ to 0.970 g/cm³.

In some embodiments, a Ziegler-Natta (ZN) catalyst is used. Such catalysts are based on a Group IVB transition metal compound and an organoaluminum compound (co-catalyst). Such transition metals, include, but not limited to, Ti, Zr, and Hf. Nonlimiting examples of ZN catalyst systems include TiCl₄+Et₃Al and TiCl₃+AlEt₂Cl. Such HDPE homopolymers and/or copolymers have some long-chain branching and a density in the range of from 0.940 g/cm³ to 0.970 g/cm³.

In some embodiments, virgin PE described herein are prepared according to the processes and conditions found in U.S. Pat. Nos. 9,249,286 and 10,501,613, the disclosure of each is fully incorporated by reference herein. In other embodiments, virgin PE described herein are prepared according to the processes and conditions found in PCT Pub. Nos. WO20140134193, WO20160206959, WO20160206958, WO20160206957, and WO20190121234, the disclosure of each is fully incorporated by reference herein. In yet other embodiments, the HDPE described herein are prepared according to the processes and conditions found in “Introduction to Industrial Polyethylene” by Dennis B. Malpass (2010), the disclosure of which is fully incorporated by reference herein. For example, a PE having the ESCR, zero shear viscosity, and/or LCBI properties described herein can be prepared using a chromium catalyst under system conditions such as an operating pressure of about 590-620 PSI, an operating temperature of about 205-230° F., a residence time of about 0.7-0.9 hours.

### Compounding Extruder

In some embodiments, the filled HDPE recyclate component and the virgin PE component are fed to an extruder or mixer wherein the blend is subjected to compounding conditions. Compounding conditions are implemented in an extruder or mixer and are tailored for mixtures of specific polyolefins and optionally additives, such as, but not limited to a one or more primary antioxidants, one or more secondary antioxidants, and/or peroxides. Temperature, pressure, and shear force conditions are implemented in the second extruder or mixer sufficient to provide intimate mixing of the filled HDPE recyclate component and the virgin PE component and optionally additives to produce a substantially homogeneous polymer blend of the filled HDPE recyclate component and the virgin PE component. In some embodiments, compounding conditions comprise a temperature in the compounding zone of less than or equal to 300° C., less than or equal to 250° C. or less than or equal to 200° C. In some embodiments, temperatures in the compounding zone can be in the range of from 130° C. to 280° C., from 140° C. to 265° C., or from 150° C. to 250° C.

In some embodiments, the filled HDPE recyclate component and the virgin PE component are fed to a twin-screw extruder and blend under compounding conditions.

### Antioxidants

In some embodiments, primary and/or secondary antioxidants are added to stabilize the reactions for any exposure to oxygen during compounding.

Primary antioxidants react rapidly with peroxy and alkoxy radicals. Examples of primary antioxidants, sometimes termed “long-term antioxidants,” include phenolic antioxidants and hindered amine antioxidants, such as are disclosed in U.S. Pat. No. 6,392,056, the disclosure of which is incorporated herein in its entirety. Suitable primary antioxidants include, but are not limited to, Irganox™ antioxidants available from BASF, such as Irganox™ 1010, Irganox™ 1076, Irganox™ 1098, Irganox™ 1330, Irganox™ 1425 WL, Irganox™ 3114, Irganox™ 245 and Irganox™ 1135. Examples of suitable antioxidants, including phenolic antioxidants and hindered amine antioxidants, are described in U.S. Pat. No. 7,285,617, the disclosure of which is incorporated herein in its entirety.

Nonlimiting examples of primary antioxidants include 2,6-di-tert.butyl-4-methyl phenol, pentaerythrityl-tetrakis(3-(3′,5′-di-tert.butyl-4-hydroxyphenyl)-propionate, octadecyl 3-(3′,5′-di-tert.butyl-4-hydroxyphenyl) propionate, 1,3,5-tri-methyl-2,4,6-tris-(3,5-di-tert.butyl-4-hydroxyphenyl)benzene, 1,3,5-tris(3′,5′-di-tert.butyl-4′-hydroxybenzyl)-isocyanurate, bis-(3,3-bis-(4-′-hydroxy-3′-tert.butylphenyl) butanic acid)-glycolester, N,N′-hexamethylene bis(3,5-di-tert.butyl-4-hydroxy-hydrocinnamamide, 2,5,7,8-Tetramethyl-2 (4′,8′,12′-trimethyltridecyl) chroman-6-ol, 2,2′-ethylidenebis(4,6-di-tert.butylphenol), 1,1,3-tris(2-methyl-4-hydroxy-5-tert.butylphenyl) butane, 1,3,5-tris(4-tert.butyl-3-hydroxy-2,6-dimethylbenzyl)-1,3,5-triazine-2,4,-6-(1H,3H,5H)-trione, 3,9-bis(1,1-dimethyl-2-(beta-(3-tert.butyl-4-hydroxy-5-methylphenyl) propionyloxy)ethyl)-2,4,8,10-tetraoxaspiro(5,5) undecane, 1,6-hexanediyl-bis(3,5-bis(1,1-dimethylethyl)-4-hydroxybenzene-propanoate-), 2,6-di-tert.butyl-4-nonylphenol, 4,4′-butylidenebis(6-tert.butyl-3-methylphenol), 2,2′-methylene bis(4-methyl-6-tert.butylphenol), and triethyleneglycol-bis-(3-tert.butyl-4-hydroxy-5 methylphenyl) propionate.

Secondary antioxidants, sometimes termed “short-term antioxidants,” can be added to the mixer/extruder at any convenient location. Secondary antioxidants are available commercially, such as the Irgafos™ antioxidants available from BASF, such as Irgafos™ 168, Irgafos™ 126, Irganox™ PS 800 and Irganox™ PS 802.

Examples of secondary antioxidants include, for example, aliphatic thiols and phosphites and phosphonites. Specific examples of secondary antioxidants include distearyl pentaerythritol diphosphite, isodecyl diphenyl phosphite, diisodecyl phenyl phosphite, tris(2,4-di-t-butylphenyl) phosphite, dilauryl thiodipropionate, 2-naphthyl disulfide, thio-2-naphthol, 2-mercaptobenzothiazole, benzothiazyl disulfide, phenothiazine, tris(p-nonylphenyl) phosphite, and zinc dimethyldithiocarbamate.

### Peroxides

In some embodiments, peroxide-modified resins can be used in the blends. Peroxide treatment conditions are implemented in an extruder. In some embodiments, peroxide treatment conditions mean subjecting a mixture of HDPE and peroxide to pressure, temperature, and shear force conditions sufficient for the peroxide to react with the HDPE to result in scission of the polymer chains and/or attachment of some polymer chains along the backbone of other polymer chains to produce long chain branching.

In some embodiments, the amount of a peroxide radical initiator added to the polyethylene composition is in the range of from 0.1 to 100 ppm by weight, alternatively from 0.5 to 100 ppm by weight, of peroxide to polyethylene composition. In some embodiments, the amount of a peroxide radical initiator added to the polyethylene composition is determined via rheology or via film testing. In some embodiments, the amount of radical initiator added to the polyethylene composition is determined via desired change in the rheological polydispersity ER. In some embodiments, the amount of radical initiator added to the polyethylene composition is determined via bubble stability testing.

In some embodiments, the filled HDPE recyclate component, the virgin PE component, and/or the blend composition are treated with a peroxide under temperature, pressure, and shear force conditions in an extruder sufficient to increase the long chain branching and thereby the processability of the filled HDPE recyclate component, the virgin PE component, and/or the blend composition, as the case may be. The blend composition can also be treated with peroxide during the process of blending the filled HDPE recyclate component and the virgin PE component while under compounding conditions in and extruder or mixer. Improving processability of the filled HDPE recyclate component and/or the virgin PE component prior to blending will improve processability of the composition after blending the components.

In some embodiments, the filled HDPE recyclate component, the virgin PE component, and/or the blend composition are treated under compounding conditions as disclosed herein. In some embodiments, a temperature in the range of from 150° C. to 250° C. is believed, without wishing to be bound by any particular theory, favors long chain branching over chain scission such that the treated polymer has a higher degree of long chain branching and improved processability through higher melt strength. It is believed that more long chain branching occurs as the temperature is reduced from 250° C. to 150° C.

Nonlimiting examples of suitable radical initiators include one or more of the group consisting of 3-hydroxy-1,1-dimethylbutyl peroxyneodecanoate, a-cumyl peroxyncodecanoate, 2-hydroxy-1,1-dimethylbutyl peroxyneoheptanoate a-cumyl peroxyncoheptanoate, t-amyl peroxyncodecanoate, t-butyl peroxyneodecanoate, di(2-ethylhexyl) peroxydicarbonate, di(n-propyl) peroxydicarbonate, di(sec-butyl) peroxydicarbonate, t-butyl peroxyncoheptanoate, t-amyl peroxypivalate, t-butyl peroxypivalate, diisononanoyl peroxide, didodecanoyl peroxide, 3-hydroxy-1,1-dimethylbutylperoxy-2-ethylhexanoate, didecanoyl peroxide, 2,T-azobis (isobutyronitrile), di(3-carboxypropionyl) peroxide, 2,5-dimethyl-2,5-di(2-ethylhexanoylperoxy) hexane, dibenzoyl peroxide, t-amylperoxy 2-ethylhexanoate, t-butylperoxy 2-ethylhexanoate, t-butyl peroxyisobutyrate, t-butyl peroxy-(cis-3-carboxy) propenoate, 1,1-di(t-amylperoxy) cyclohexane, 1,1-di(t-butylperoxy)-3,3,5-trimethylcyclohexane, 1,1-di(t-butylperoxy) cyclohexane, OO-t-amyl O-(2-ethylhexyl) monoperoxycarbonate, OO-t-butyl O-isopropyl monoperoxycarbonate, OO-t-butyl O-(2-ethylhexyl) monoperoxycarbonate, polyether tetrakis(t-butylperoxycarbonate), 2,5-dimethyl-2,5-di(benzoylperoxy) hexane, t-amyl peroxyacetate, t-amyl peroxybenzoate, t-butyl peroxyisononanoate, t-butyl peroxyacetate, t-butyl peroxybenzoate, di-t-butyl diperoxyphthalate, 2,2-di(t-butylperoxy) butane, 2,2-di(t-amylperoxy) propane, n-butyl 4,4-di(t-butylperoxy) valerate, ethyl 3,3-di(t-amylperoxy) butyrate, ethyl 3,3-di(t-butylperoxy) butyrate, dicumyl peroxide, a,a′-bis(t-butylperoxy) diisopropylbenzene, 2,5-dimethyl-2,5-di(t-butylperoxy) hexane, di(t-amyl) peroxide, t-butyl a-cumyl peroxide, di(t-butyl) peroxide, 2,5-dimethyl-2,5-di(t-butylperoxy)-3-hexyne, dicetil peroxi-dicarbonato, 3,6,9-triethyl-3,6,9-trimethyl-1,4,7-triperoxonane, tert-butylperoxy 2-ethylhexyl carbonate, tert-butyl-peroxide n-butyl fumarate (benzoate), dimyristoyl peroxydiicarbonate, 3,3,5,7,7-pentamethyl-1,2,4-trioxepane, tert-butyl hydroperoxide, bis(4-t-butylcyclohexyl) peroxydicarbonate, and 1,2,4,5,7,8-hexoxonane,3,6,9-trimethyl-3,6,9-tris(ethyl and propyl derivatives).

### Certain Embodiments

In some embodiments, a composition comprises a blend of a filled HDPE recyclate component and a virgin PE component. The filled HDPE recyclate component has a density in the range of from 0.950 g/cm³ to 0.970 g/cm³, an ash content of 5,000 ppm to 20,000 ppm, a melt index (I₅) in the range of from 1.50 g/10 min. to 7.0 g/10 min.; and an environmental stress crack resistance (“ESCR”) F10 from about 10 to about 24 hours in 10% Igepal. The virgin PE component has i) a density in the range of from 0.938 g/cm³ to 0.954 g/cm³, an Is in the range of from 0.10 g/10 min. to 2.0 g/10 min., and an ESCR F50 of greater than or equal to 1,000 hours in 100% Igepal and/or 10% Igepal.

In some embodiments, the filled HDPE recyclate component is present in the blend in an amount in the range of from 20 wt. % to 95 wt. %, from 50 wt. % to 90 wt. %, from 60 wt. % to 85 wt. %, or from 70 wt. % to 80 wt. %, and the virgin PE component is present in the blend in an amount in the range of from 5 wt. % to 80 wt. %, from 10 wt. % to 50 wt. %, from 15 wt. % to 40 wt. %, or from 20 wt. % to 30 wt. %, respectively. Weight percentages are based on the total weight of the filled HDPE recyclate and virgin PE components.

In some embodiments of the blended composition, in addition to any one or more of the foregoing limitations, the composition is further characterized in that the virgin PE component has an Is at least 0.02 g/10 min. lower than the Is of the filled HDPE recyclate component, and/or an ESCR F50 in 100% Igepal at least 100 hours greater than the ESCR F50 in 100% Igepal at least 100 hours of the filled HDPE recyclate component.

In some embodiments of the blend composition, in addition to any one or more of the foregoing limitations, the composition is further characterized in that the filled HDPE recyclate component has one or more of:
a) a Mₙ in the range of from 8,000 g/mol to 20,000 g/mol or from 12,000 g/mol to 16,000 g/mol;
b) a M_{w} in the range of from 100,000 g/mol to 170,000 g/mol or from 115,000 g/mol to 145,000 g/mol;
c) a MWD in the range of from 5 to 14 or from 6 to 9;
d) a HLMI in the range of from 35 g/10 min. to 70 g/10/min. or from 40 g/10 min. to 65 g/10/min.; and
e) a 2% flexural modulus in the range of from 170,000 PSI to 230,000 PSI or from 180,000 PSI to 210,000 PSI.

In some embodiments of the composition, in addition to any one or more of the foregoing limitations, the composition is further characterized in that the filled HDPE recyclate component has one or more of:
a) a zero shear viscosity (η₀) in the range of from 5.0×10⁶ to 1.0×10⁸;
b) a bulk intrinsic viscosity ([η]) in the range of from 1.0 to 2.5; and
c) a long chain branching index (LCBI) in the range of from 0.1 to 4.0.

In some embodiments of the composition, in addition to any one or more of the foregoing limitations, the composition is further characterized in that the virgin PE component has one or more of:
a) a Mₙ in the range of from 7,000 g/mol to 25,000 g/mol or from 12,000 g/mol to 22,000 g/mol;
b) a M_{w} in the range or from 100,000 g/mol to 1,000,000 g/mol or from 200,000 g/mol to 300,000 g/mol;
c) a MWD in the range of from 5 to 40 or from 7 to 30;
d) a HLMI in the range of from 5 g/10 min. to 40 g/10/min. or from 7 g/10 min. to 30 g/10/min.; and
e) a 2% flexural modulus in the range of from 80,000 PSI to 180,000 PSI or from 136,000 PSI to 146,000 PSI.

In some embodiments of the composition, in addition to any one or more of the foregoing limitations, the composition is further characterized in that the virgin PE component has one or more of:
a) a zero shear viscosity (η₀) in the range of from 1.0×10⁵ to 1.0×10⁸;
b) a bulk intrinsic viscosity ([η]) in the range of from 1.80 to 3.00;
c) a viscosity ratio in the range of from 0.800 to 1.150, and
d) a long chain branching index (LCBI) in the range of from 0.1 to 2.0.

In some embodiments of the blended composition, in addition to any one or more of the foregoing limitations, the composition is further characterized in that the blend composition has one or more of:
a) a melt index (I₅) in the range of from 0.20 g/10 min. to 4.0 g/10 min. or from 0.80 g/10 min. to 1.80 g/10 min.; and
b) an environmental stress crack resistance (“ESCR”) F10 that is greater than or equal to 96 hours in 10% Igepal.
c) a Mₙ in the range of from 10,000 g/mol to 20,000 g/mol;
d) a M_{w} in the range of from 130,000 g/mol to 230,000 g/mol or from 156,000 g/mol to 194,000 g/mol;
e) a MWD in the range of from 8 to 20 or from 10 to 15;
f) a HLMI in the range of from 10 g/10 min. to 60 g/10/min. or from 20 g/10 min. to 40 g/10/min;
g) an overall polydispersity ratio (PDR) in the range of from 15 to 80 or in the range of from 15 to 60;
h) a zero shear viscosity (η₀) in the range of from 1.0×10⁶ to 1.0×10⁸;
i) a long chain branching index (LCBI) in the range of from 0.1 to 3;
j) a tensile strength at yield of about 3000 to about 4000 PSI; and,
k) a 2% flexural modulus in the range of from 110,000 PSI to 170,000 PSI or from 140,000 PSI to 150,000 PSI.

In some embodiments of the composition, in addition to any one or more of the foregoing limitations, the filled HDPE recyclate component comprises:
a) one or more filled HDPE recyclates and optionally one or more virgin PEs; or
b) one or more filled HDPE homopolymer recyclates, one or more filled HDPE copolymer recyclates, or a combination thereof.

In some embodiments of the composition, in addition to any one or more of the foregoing limitations, the virgin PE component comprises one or more virgin PE homopolymers, one or more virgin PE copolymers, or a combination thereof.

In some embodiments of the composition, in addition to any one or more of the foregoing limitations, the composition is further characterized in that prior to blending, the filled HDPE recyclate component and/or the virgin PE component are treated with a peroxide, or during or after blending, the blend composition is treated with peroxide. Such peroxide treatment of the relevant component(s) or the composition is implemented at a temperature in the range of 150° C. to 270° C. under pressure and shear force conditions implemented in an extruder sufficient to increase the melt strength of the final blend composition as compared to a corresponding blend composition wherein the relevant component(s) or the composition are not so treated with peroxide.

In some embodiments of the composition, in addition to any one or more of the foregoing limitations, the filled HDPE recyclate component and the virgin PE component are melt blended at a temperature in the range of from 150° C. to 250° C. In further embodiments, the blend further comprises one or more primary antioxidants, one or more a secondary antioxidant, or a combination thereof. In further embodiments, the total primary antioxidant and/or the total secondary antioxidant each can be present in the blend at up to 1,900 ppm, up to 1,500 ppm, or up to 1,000 ppm, based on the total weight of the filled HDPE recyclate component and the virgin PE component.

The following examples illustrate the invention; however, those skilled in the art will recognize numerous variations within the spirit of the invention and scope of the claims. To facilitate a better understanding of the present invention, the following examples of preferred embodiments are given. In no way should the following examples be read to limit, or to define, the scope of the invention.

### EXAMPLES

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

The following examples use commercially available virgin PE compositions with a commercially available recyclate feedstock.

### Test Methods

Environmental Stress Crack Resistance (ESCR)—The resin environmental stress crack resistance (“ESCR”) was measured in accordance with ASTM-D 1693-01, Method B. In accordance with this test, the susceptibility of a resin to mechanical failure by cracking is measured under constant strain conditions, and in the presence of a crack accelerating agent, such as a soap or other wetting agent. Measurements were carried out on notched specimens, in a 10 percent, by volume, Igepal CO-630 (vendor Rhone-Poulec, NJ) aqueous solution, maintained at 50° C. Ten specimens were evaluated per measurement. The ESCR value of the resin was reported as F50, the calculated 50 percent failure time from the probability graph.

Ash content is determined in accordance with ASTM D-5630. Virgin PE resins have an ash content of about 3 to about 500 ppm, depending on the additives and with no fillers. Filled PE resins have an ash content of greater than 5000 ppm due to the filler and/or additives.

Densities are determined in accordance with ASTM D-4703 and ASTM D-1505/ISO-1183.

High load melt index (“I₂₁”) was determined by ASTM D-1238-F (190° C./21.6 kg).

Shear rheological measurements are performed in accord with ASTM 4440-95a, which characterize dynamic viscoelastic properties (storage modulus, G′, loss modulus, G″ and complex viscosity, η*, as a function of oscillation frequency, ω). A rotational rheometer (TA Instruments) is used for the rheological measurements. A 25 mm parallel-plate fixture was utilized. Samples were compression molded in disks (˜29 mm diameter and ˜1.3 mm thickness) using a hot press at 190° C. An oscillatory frequency sweep experiment (from 398.1 rad/s to 0.0251 rad/s) was applied at 190° C. The applied strain amplitude is ˜10% and the operating gap is set at 1 mm. Nitrogen flow was applied in the sample chamber to minimize thermal oxidation during the measurement.

Melt elasticity (“ER”) is determined as discussed in R. Shroff and H. Mavridis, “New Measures of Polydispersity from Rheological Data on Polymer Melts,” J. Applied Polymer Science 57 (1995) 1605. See also U.S. Pat. Nos. 7,238,754, 6,171,993 and 5,534,472 (col. 10, lines 20-30), the teachings of which are incorporated herein by reference. Thus, storage modulus (G′) and loss modulus (G″) are measured. The nine lowest frequency points are used (five points per frequency decade) and a linear equation is fitted by least-squares regression to log G′ versus log G″. ER is then calculated from:

$$ER = ( 1.7 \; 81 \times {10}^{- 3} ) \times {G}^{′}$$

at a value of G″=5,000 dyn/cm². The same procedure and equation for the ER calculation was used for both linear and long-chain-branched polyolefins.

PDR, or “Overall Polydispersity Measure” is determined as discussed in R. Shroff and H. Mavridis, “New Measures of Polydispersity from Rheological Data on Polymer Melts,” J. Applied Polymer Science 57 (1995) 1605, equation 27 on page 1619, with G*_{ref,1}=1.95*10⁴ dyn/cm² and log₁₀(G*_{ref,3}/G*_{ref,1})=2. The same procedure and equation for the PDR calculation was used for both linear and long-chain-branched polyolefins.

The ratio θ*_{0.1}/n*₁₀₀ of complex viscosities, θ*_{0.1}, at a frequency of 0.1 rad/sec and n*₁₀₀, at a frequency of 100 rad/sec, is used as an additional measure of shear sensitivity and thus rheological breadth, or polydispersity, of the polymer melt.

Melt index (“I₂”) was determined by ASTM D-1238-E (190° C./2.16 kg).

Melt index (“I₅”) was determined by ASTM D-1238 (190° C./5 kg).

Molecular weight distribution (“MWD”), which is also called M_{z}/M_{w}, as well as the molecular weight averages (number-average molecular weight, Mₙ weight-average molecular weight, M_{w}, z-average molecular weight, M_{z}, and z+1 average molecular weight, M_{z}+1) are determined using a high temperature Polymer Char gel permeation chromatography (“GPC”), also referred to as size exclusion chromatography (“SEC”), equipped with a filter-based infrared detector, IR5, a four-capillary differential bridge viscometer, and a Wyatt 18-angle light scattering detector. Mₙ, M_{w}, M_{z}, MWD, and short chain branching (SCB) profiles are reported using the IR detector, whereas long chain branch parameter, g′, is determined using the combination of viscometer and IR detector at 145° C. Three Agilent PLgel Olexis GPC columns are used at 145° C. for the polymer fractionation based on the hydrodynamic size in 1,2,4-trichlorobenzene (TCB) with 300 ppm antioxidant butylated hydroxytoluene (BHT) as the mobile phase. 16 mg polymer is weighted in a 10 mL vial and sealed for the GPC measurement. The dissolution process is obtained automatically (in 8 ml TCB) at 160° C. for a period of 1 hour with continuous shaking in an Agilent autosampler. 20 μL Heptane was also injected in the vial during the dissolution process as the flow marker. After the dissolution process, 200 μL solution was injected in the GPC column. The GPC columns are calibrated based on twelve monodispersed polystyrene (PS) standards (provided by PSS) ranging from 578 g/mole to 3,510,000 g/mole. The comonomer compositions (or SCB profiles) are reported based on different calibration profiles obtained using a series of relatively narrow polyethylene (polyethylene with 1-hexene and 1-octene comonomer were provided by Polymer Char, and polyethylene with 1-butene were synthesized internally) with known values of CH₃/1000 total carbon, determined by an established solution NMR technique. GPC one software was used to analyze the data. The long chain branch parameter, g′, is determined by the equation:

$${g}^{′} = [ η ] {/ [ η ]}_{lin}$$

where, [η] is the average intrinsic viscosity of the polymer that is derived by summation of the slices over the GPC profiles as follows:

$$[ η ] = \frac{\sum {{c}_{i} [ η ]}_{i}}{\sum {c}_{i}}$$

where cᵢ is the concentration of a particular slice obtained from IR detector, and [η]ᵢ is the intrinsic viscosity of the slice measured from the viscometer detector. [η]ₗᵢₙ is obtained from the IR detector using Mark-Houwink equation ([η]ₗᵢₙ=ΣKMᵢ^{α}) for a linear high density polyethylene, where Mᵢ is the viscosity-average molecular weight for a reference linear polyethylene, K and α are Mark-Houwink constants for a linear polymer, which are K=0.000374, α=0.7265 for a linear polyethylene and K=0.00041, α=0.6570 for a linear polypropylene.

Zero-shear viscosity, η₀, is determined using the Sabia equation fit of dynamic complex viscosity versus radian frequency, as described in of Shroff & Mavridis, (1999) “A Long Chain Branching Index for Essentially Linear Polyethylenes”, Macromolecules, 32, 8454-8464 (with focus on Appendix B), the disclosure of which is fully incorporated by reference herein in its entirety.

LCBI is determined using equation 13:

$$LCBI = \frac{{η}_{\text{?}}^{\text{?}}}{[ η ]} \frac{1}{4.8} - 1 \qquad ( 13 )$$

$$\text{?} \text{indicates text missing or illegible when filed}$$

Equation 13 and its application are described in of Shroff & Mavridis, (1999) “A Long Chain Branching Index for Essentially Linear Polyethylenes”, Macromolecules, 32, 8454-8464, the disclosure of which is fully incorporated by reference herein in its entirety.

### Raw Materials

Raw materials used herein are shown in TABLES 1-5, below. FHC1 identifies and shows properties of the recyclate HDPE components used in the HDPE blends disclosed herein. SHC1 and SHC2 identify and show properties of virgin PE components used in the blends disclosed herein.

TABLE 1 lists composition type and grade number of the raw materials along with a label identifier as used in the examples below in TABLES 2-9.

TABLE 1

| Label | Composition | Grade |
|---|---|---|
| FHC1 | HDPE Recyclate | Envision 9534M |
| SHC1 | HDPE bimodal copolymer | Alathon L4930TC ¹ |
| SHC2 | HDPE bimodal copolymer | Alathon L5008HP ¹ |
| SHC3 | HDPE unimodal copolymer | Petrothene LP540200¹ |

¹ Available from LyondellBasell, Houston, TX

TABLE 2 lists the density, I₂, I₅, HLMI, ESCR F50, 100% Igepal, and ash content for the polymers identified in TABLE 1.

TABLE 2

| | | | | | ESCR F50, | |
|---|---|---|---|---|---|---|
| | | | | | 100% | Ash |
| | Density, | I₂ | I₅ | HLMI, | Igepal, | Content |
| Polymer | (g/cc) | (dg/min) | (dg/min) | (dg/min) | (hrs.) | (ppm) |
| FHC1 | 0.9608 | 0.7 | 2.79 | 60.5 | 24 | 12554 |
| SHC1 | 0.9494 | 0.281 | 1.09 | 25.8 | >1000 | 150 |
| SHC2 | 0.9518 | 0.08 | 0.42 | 15.4 | >1000 | 280 |
| SHC3 | 0.9397 | 0.13 | 0.68 | 15.7 | >1000 | 319 |

TABLE 3 lists the M_{w}, Ma, M_{w}/Mₙ (MWD), M_{z}/M_{w}, M_{z}, and M_{z+1} for the polymers identified in TABLE 1.

TABLE 3

| | M_{w} | Mₙ | M_{w}/Mₙ | | M_{z} | M_{z+1} |
|---|---|---|---|---|---|---|
| Polymer | (g/mol) | (g/mol) | (MWD) | M_{z}/M_{w} | (g/mol) | (g/mol) |
| FHC1 | 133,400 | 12,600 | 10.58 | 4.1 | 551,500 | 1,224,000 |
| SHC1 | 199,300 | 10,000 | 19.9 | 4.8 | 962,700 | 1,849,300 |
| SHC2 | 252,500 | 10,600 | 23.78 | 5.6 | 1,411,200 | 2,698,100 |
| SHC3 | 164,350 | 9,050 | 18.22 | 4.7 | 772,750 | 2,138,000 |

TABLE 4 lists the ER, PDR, ETA0, ETA*100, ETA*1000, and IV for the polymers identified in TABLE 1.

TABLE 4

| | | | ETA0 (from | | | |
|---|---|---|---|---|---|---|
| Polymer | ER | PDR | PDR) | ETA*100 | ETA*1000 | IV (dL/g) |
| FHC1 | 5.37 | 48.4 | 78,980,000 | 10,100 | 2,435 | 1.67 |
| SHC1 | 2.60 | 17.1 | 1,070,000 | 14,700 | 3,566 | 2.13 |
| SHC2 | 2.90 | 42.8 | 5,480,000 | 17,200 | 2969 | 2.45 |
| SHC3 | 5.58 | 50.1 | 66,300,000 | 16,200 | 3,423 | 1.91 |

TABLE 5 lists the bulk comonomer, bulk IV, viscosity ratio, and LCBI for the polymers identified in TABLE 1.

TABLE 5

| | Bulk Comon. | Bulk IV | Viscosity | |
|---|---|---|---|---|
| Polymer | (wt. %) | (dL/g) | Ratio | LCBI |
| FHC1 | 12.5 | 1.44 | 1.155 | 2.24 |
| SHC1 | 1.64 | 2.02 | 1.055 | 0.18 |
| SHC2 | 1.64 | 2.32 | 1.056 | 0.44 |
| SHC3 | 3.12 | 1.77 | 1.080 | 1.74 |

### Examples 1-14

Examples 1-13 in TABLES 6-9 show the parameters and properties of blends of FHC1 with one or more amounts of each of SHC1, SHC2, and SHC3.

TABLE 6 lists the weight percentages of polymers FHC1, SHC1, SHC2, and SHC3 used in blend Examples 1-13. Properties of these blends are shown in TABLES 7-11.

TABLE 6

| Example | FHC1 | SHC1 | SHC2 | SHC3 |
|---|---|---|---|---|
| 1 | 20 | 80 | — | — |
| 2 | 30 | 70 | — | — |
| 3 | 40 | 60 | — | — |
| 4 | 50 | 50 | — | — |
| 5 | 30 | — | 70 | — |
| 6 | 40 | — | 60 | — |
| 7 | 50 | — | 50 | — |
| 8 | 60 | — | 40 | — |
| 9 | 70 | — | 30 | — |
| 10 | 75 | — | 25 | — |
| 11 | 40 | — | — | 60 |
| 12 | 50 | — | — | 50 |
| 13 | 60 | — | — | 40 |

TABLE 7 lists the density, I₂, I₅, HLMI, and ESCR F50, 100% Igepal for the example blends as identified in TABLE 6.

TABLE 7

| | | | | | ESCR | ESCR |
|---|---|---|---|---|---|---|
| | | | | | F50, | F50, |
| | | | | | 100% | 10% |
| | Density, | I₂ | I₅ | HLMI, | Igepal, | Igepal, |
| Example | (g/cc) | (dg/min) | (dg/min) | (dg/min) | (hrs.) | (hrs.) |
| 1 | 0.9524 | 0.306 | 1.33 | 29.8 | >1000 | 515.6 |
| 2 | 0.9532 | 0.323 | 1.42 | 32.2 | >1000 | 237 |
| 3 | 0.9540 | 0.342 | 1.50 | 35 | >1000 | 158.9 |
| 4 | 0.9548 | 0.368 | 1.71 | 38.6 | >720 | 103.6 |
| 5 | 0.9546 | 0.109 | 0.629 | 23.5 | >1000 | >1000 |
| 6 | 0.9555 | 0.14 | 0.783 | 27.5 | >1000 | >1000 |
| 7 | 0.9562 | 0.155 | 0.947 | 28.9 | >1000 | 672 |
| 8 | 0.9566 | 0.241 | 1.3 | 37.1 | >1000 | 154.2 |
| 9 | 0.9568 | 0.286 | 1.64 | 42.9 | 417.6 | 85.9 |
| 10 | 0.9579 | 0.34 | 1.84 | 46.1 | 208.9 | 30.7 |
| 11 | 0.9479 | 0.275 | 1.11 | 26.7 | >1000 | 259.2 |
| 12 | 0.9497 | 0.283 | 1.23 | 29.8 | >1000 | 132 |
| 13 | 0.9522 | 0.315 | 1.41 | 34 | 842.4 | 74.4 |

TABLE 8 lists the M_{w}, Mₙ, M_{w}/Mₙ, M_{z}/M_{w}, M_{z}, and M_{z+1} for the example blends as identified in TABLE 6.

TABLE 8

| | M_{w} | Mₙ | M_{w}/Mₙ | | M_{z} | M_{z+1} |
|---|---|---|---|---|---|---|
| Example | (g/mol) | (g/mol) | (MWD) | M_{z}/M_{w} | (g/mol) | (g/mol) |
| 1 | 171,400 | 7,900 | 21.66 | 4.35 | 745,100 | 1,512,000 |
| 2 | 165,400 | 7,800 | 21.17 | 4.20 | 694,400 | 1,319,500 |
| 3 | 159,400 | 8,300 | 19.27 | 4.22 | 672,100 | 1,301,900 |
| 4 | 153,800 | 8,600 | 17.84 | 4.25 | 653,400 | 1,296,000 |
| 5 | 200,900 | 10,000 | 20.16 | 4.56 | 916,800 | 1,683,300 |
| 6 | 189,500 | 10,000 | 18.96 | 4.66 | 883,400 | 1,739,800 |
| 7 | 177,900 | 10,400 | 17.07 | 4.6 | 825,400 | 1,622,000 |
| 8 | 166,300 | 10,400 | 16 | 4.77 | 792,500 | 1,699,000 |
| 9 | 155,500 | 9,700 | 16.09 | 4.71 | 732,000 | 1,561,500 |
| 10 | 150,500 | 10,400 | 14.48 | 4.68 | 703,900 | 1,560,900 |
| 11 | 142,300 | 8,800 | 16.26 | 4.39 | 624,600 | 1,472,500 |
| 12 | 137,800 | 9,600 | 14.34 | 4.25 | 585,800 | 1,330,600 |
| 13 | 136,500 | 9,500 | 14.37 | 4.28 | 584,300 | 1,333,200 |

TABLE 9 lists the ER, PDR, ETA0, ETA*100, ETA*1000, and IV for the example blends as identified in TABLE 6.

TABLE 9

| | | | ETA0 | | | |
|---|---|---|---|---|---|---|
| | | | (from | | | |
| Example | ER | PDR | PDR) | ETA*100 | ETA*1000 | IV (dL/g) |
| 1 | 2.95 | 20.4 | 1,180,000 | 14,200 | 2949 | 1.94 |
| 2 | 3.16 | 22.9 | 1,430,000 | 13,600 | 2896 | 1.90 |
| 3 | 3.37 | 26.1 | 1,540,000 | 12,400 | 2706 | 1.86 |
| 4 | 3.57 | 28.5 | 1,890,000 | 11,900 | 2641 | 1.81 |
| 5 | 3.41 | 48.7 | 5,580,000 | 16,200 | 3124 | 2.14 |
| 6 | 3.65 | 53 | 5,690,000 | 15,000 | 3036 | 2.06 |
| 7 | 3.84 | 56.1 | 6,540,000 | 14,400 | 2981 | 1.98 |
| 8 | 3.98 | 59.7 | 7,140,000 | 12,300 | 2631 | 1.89 |
| 9 | 4.21 | 60.6 | 10,000,000 | 11,300 | 2520 | 1.81 |
| 10 | 4.41 | 64.3 | 13,700,000 | 10,100 | 2253 | 1.78 |
| 11 | 5.54 | 49.5 | 59,800,000 | 13,600 | 3129 | 1.73 |
| 12 | 5.63 | 50.6 | 65,400,000 | 13,100 | 3036 | 1.70 |
| 13 | 5.44 | 52.3 | 64,100,000 | 1,200 | 2825 | 1.69 |

TABLE 10 lists the Bulk Comonomer, Bulk IV, Viscosity Ratio, LCBI, and LCB/10⁶ C for the example blends as identified in TABLE 6.

TABLE 10

| | Bulk | | | | |
|---|---|---|---|---|---|
| | Comon. | Bulk IV | Viscosity | | |
| Example | (wt. %) | (dL/g) | Ratio | LCBI | LCB/10⁶ C |
| 1 | 4.2 | 1.8569 | 1.0466 | 0.31 | 12 |
| 2 | 4.9 | 1.7987 | 1.0573 | 0.39 | 14.3 |
| 3 | 5.2 | 1.7613 | 1.0539 | 0.44 | 16.3 |
| 4 | 5.6 | 1.7085 | 1.0613 | 0.53 | 19.4 |
| 5 | 5 | 2.1225 | 1.0099 | 0.57 | 13 |
| 6 | 6.7 | 2.0058 | 1.0277 | 0.64 | 15.3 |
| 7 | 7.3 | 1.9177 | 1.0324 | 0.75 | 18.9 |
| 8 | 10.3 | 1.8097 | 1.0459 | 0.86 | 23.5 |
| 9 | 10.8 | 1.7447 | 1.039 | 1.06 | 32.1 |
| 10 | 10.2 | 1.6905 | 1.0523 | 1.22 | 39.8 |
| 11 | 5.9 | 1.6199 | 1.0699 | 1.96 | 91.2 |
| 12 | 6 | 1.6098 | 1.0557 | 2.07 | 91.9 |
| 13 | 6.8 | 1.5694 | 1.0746 | 2.08 | 92.1 |

TABLE 11 lists the Tensile stress and elongation at yield and at break, and Flexural Modulus (2% Secant) for the polymers identified in TABLE 6.

TABLE 11

| | Tensile | Tensile | Tensile | Tensile | |
|---|---|---|---|---|---|
| | Stress at | Elongation | Stress at | Elongation | Flexural |
| Example | yield | at yield | break | at break | Modulus |
| 1 | 3740 | 9.2 | 3150 | 690 | 147,500 |
| 2 | 3770 | 9.3 | 2530 | 510 | 145,900 |
| 3 | 3750 | 9.3 | 2280 | 420 | 147,800 |
| 4 | 3790 | 9.3 | 2340 | 540 | 148,500 |
| 5 | 3770 | 9 | 3020 | 650 | 154,200 |
| 6 | 3810 | 8.9 | 2660 | 630 | 155,800 |
| 7 | 3810 | 8.6 | 2460 | 620 | 153,000 |
| 8 | 3800 | 9.2 | 2380 | 420 | 151,600 |
| 9 | 3830 | 9.3 | 2340 | 450 | 153,300 |
| 10 | 3820 | 9.2 | 2220 | 400 | 150,700 |
| 11 | 3280 | 10 | 2990 | 670 | 120,100 |
| 12 | 3370 | 10 | 2520 | 640 | 123,800 |
| 13 | 3480 | 9.8 | 2420 | 660 | 131,400 |

The results for the blends in Table 6 have suitable properties for use in conduit applications. Other combinations of the filled recyclate HDPE and virgin PE are expected to find use in many applications.

For the sake of brevity, only certain ranges are explicitly disclosed herein. However, in addition to recited ranges, any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the processes, machines, film structures, composition of layers, means, methods, and/or steps described in the specification. As one of the ordinary skill in the art will readily appreciate from the disclosure of the present invention, processes, machines, film structures, composition of layers, means, methods, and/or steps, presently existing or later to be developed that perform substantially the same function or achieve substantially the same result as the corresponding embodiments described herein, may be utilized according to the present invention. Accordingly, the appended claims are intended to include within their scope such processes, machines, film structures, composition of layers, means, methods, and/or steps.

What is claimed is:

1. A composition comprising a blend of:
a) from 20 wt. % to 95 wt. % of a filled high density polyethylene (“HDPE”) recyclate component having:
i) a density in the range of from 0.950 g/cm³ to 0.970 g/cm³;
ii) an ash content of about 5,000 ppm to about 20,000 ppm;
ii) a melt index (I₅) in the range of from 1.50 g/10 min. to 7.0 g/10 min.; and
iii) an environmental stress crack resistance (“ESCR”) F10 from about 10 hours to about 24 hours in 10% Igepal; and
b) from 5 wt. % to 80 wt. % of a virgin PE component having:
i) a density in the range of from 0.938 g/cm³ to 0.954 g/cm³;
ii) an Is in the range of from 0.10 g/10 min. to 2.0 g/10 min.; and
iii) an ESCR F50 of greater than or equal to 1,000 hours in 10% Igepal;
wherein weight percentages are based on the total weight of the filled HDPE recyclate component and the virgin PE component, and
wherein the composition has a flexural modulus in the range of 140,000 to 170,000 PSI and a tensile strength at yield in the range of 3,000 to 4,000 PSI, an Is in the range of from 0.2 g/10 min. to 4.0 g/10 min, and an ESCR F10 of greater than or equal to 96 hours in 10% Igepal.

2. The composition of claim 1, wherein the filled HDPE recyclate component is present in an amount in the range of from 50 wt. % to 90 wt. % and the virgin PE component is present in an amount in the range of from 10 wt. % to 50 wt. %.

3. The composition of claim 2, wherein the filled HDPE recyclate component is present in an amount in the range of from 60 wt. % to 85 wt. % and the virgin PE component is present in an amount in the range of from 15 wt. % to 40 wt. %.

4. The composition of claim 1, wherein the filled HDPE recyclate component has one or more of:
a) a number average molecular weight (Mₙ) in the range of from 8,000 g/mol to 20,000 g/mol;
b) a weight average molecular weight (M_{w}) in the range of from 100,000 g/mol to 170,000 g/mol;
c) a molecular weight distribution (MWD; M_{w}/Mₙ) in the range of from 5 to 14;
d) a high load melt index (HLMI) in the range of from 35 g/10 min. to 90 g/10/min.; and
e) a 2% flexural modulus in the range of from 145,000 PSI to 230,000 PSI.

5. The composition of claim 1, wherein prior to blending with the virgin PE component, the filled HDPE recyclate component is treated with a peroxide at a temperature in the range of 150° C. to 270° C. under pressure and shear force conditions implemented in an extruder sufficient to increase the melt strength of the composition as compared to a corresponding blend of the filled HDPE recyclate component and the virgin PE component wherein the filled HDPE recyclate component is not so treated with peroxide.

6. The composition of claim 1, the virgin PE component has one or more of:
a) a number average molecular weight (Mₙ) in the range of from 7,000 g/mol to 25,000 g/mol;
b) a weight average molecular weight (M_{w}) in the range of from 100,000 g/mol to 1,000,000 g/mol;
c) a molecular weight distribution (MWD) in the range of from 5 to 40;
d) a high load melt index (HLMI) in the range of from 5 g/10 min. to 40 g/10/min.; and
e) a 2% flexural modulus in the range of from 80,000 PSI to 180,000 PSI.

7. The composition of claim 1, wherein prior to blending with the filled HDPE recyclate component, the virgin PE component is treated with a peroxide at a temperature in the range of 150° C. to 270° C. under pressure and shear force conditions implemented in an extruder sufficient to increase the melt strength of the composition as compared to a corresponding blend of the filled HDPE recyclate component and the virgin PE component wherein the virgin PE component is not so treated with peroxide.

8. The composition of claim 1, wherein the blend has one or more of:
a) a high load melt index (HLMI) in the range of from 10 g/10 min. to 60 g/10 min.; and
b) an environmental stress crack resistance (“ESCR”) F50 in the range of from 10 hours to greater than 1,000 hours in 100% Igepal.

9. The composition of claim 8, wherein the blend has one or more of:
a) a number average molecular weight (Mₙ) in the range of from 10,000 g/mol to 20,000 g/mol;
b) a weight average molecular weight (M_{w}) in the range of from 130,000 g/mol to 230,000 g/mol;
c) a molecular weight distribution (MWD) in the range of from 8 to 20;
d) an overall polydispersity ratio (PDR) in the range of from 15 to 80;
e) a zero shear viscosity (η₀) in the range of from 1.0×10⁶ to 1.0×10⁸; and,
f) a long chain branching index (LCBI) in the range of from 0.1 to 3.

10. The composition of claim 1, wherein the blend has one or more of:
a) a weight average molecular weight (M_{w}) in the range of from 140,000 g/mol to 150,000 g/mol;
b) a molecular weight distribution (MWD) in the range of from 10 to 15;
c) a high load melt index (HLMI) in the range of from 20 g/10 min. to 40 g/10/min.; and
d) a 2% flexural modulus in the range of from 175,000 PSI to 205,000 PSI.

11. The composition of claim 1, wherein the filled HDPE recyclate component comprises one or more HDPE recyclates and one or more virgin PEs.

12. The composition of claim 1, wherein the filled HDPE recyclate component comprises one or more HDPE homopolymer recyclates, one or more HDPE copolymer recyclates, or a combination thereof.

13. The composition of claim 1, wherein during or after blending the filled HDPE recyclate component and the virgin PE component, the blend is treated with a peroxide at a temperature in the range of 150° C. to 270° C. under pressure and shear force conditions implemented in an extruder sufficient to increase the melt strength of the composition as compared to a corresponding blend of the filled HDPE recyclate component and the virgin PE component that is not so treated with peroxide.

14. The composition of claim 1, wherein the virgin PE component comprises one or more virgin PE homopolymers, one or more virgin PE copolymers, or a combination thereof.

15. The composition of claim 1, wherein the filled HDPE recyclate component and the virgin PE component are melt blended at a temperature in the range of from 150° C. to 270° C.

16. The composition of claim 1, wherein the blend further comprises a primary antioxidant, a secondary antioxidant, or a combination thereof.

17. The composition of claim 16, wherein primary antioxidant is present in the blend in an amount less than or equal to 1,900 ppm and the secondary antioxidant is present in the blend in an amount less than or equal to 1,900 ppm, wherein ppm values are based on the total weight of the filled HDPE recyclate component and the virgin PE.

18. A conduit comprising the composition of claim 1.

19. A conduit comprising the composition of claim 16.
